(19) United States
(12) Patent Application Publication
(10) Pub. No.: US 2015/0067274 A1
(43) Pub. Date: Mar. 5, 2015

(54) MEMORY SYSTEM

(71) Applicant: SK hynix Inc., Icheon-si Gyeonggi-do (KR)

(72) Inventor: Dong Uk LEE, Icheon-si Gyeonggi-do (KR)

(21) Appl. No.: 14/067,326

(22) Filed: Oct. 30, 2013

(30) Foreign Application Priority Data
Aug. 30, 2013 (KR) 10-2013-0103769

(51) Int. Cl. G06F 3/06

(52) U.S. Cl. CPC G06F 3/0659; G06F 3/0604; G06F 3/0683
USPC 711/148

(57) ABSTRACT

A memory system, including a plurality of stacked slices and a controller electrically coupled to the plurality of slices, includes: the plurality of slices configured to share a command in a preset number unit, wherein a slice performs a data input/output operation; and the controller configured to generate the command and a control signal for selecting slices in the preset number unit from the plurality of slices.

### CROSS-REFERENCES TO RELATED APPLICATION

The present application claims priority under 35 U.S.C. §119(a) to Korean application number 10-2013-0103769, filed on Aug. 30, 2013, in the Korean Intellectual Property Office, which is incorporated herein by reference in its entirety.

### BACKGROUND

1. Technical Field

Various embodiments relate to a semiconductor circuit, and more particularly, to a memory system.

2. Description of the Related Art

A conventional memory chip can be configured with a single channel or with two channels which operate independently from each other.

FIG. 1 is a layout diagram illustrating the configuration of a conventional semiconductor memory chip 10.

As shown in FIG. 1, a conventional semiconductor memory chip 10 is configured, for example, with two channels CH_A and CH_B, wherein each channel includes a plurality of memory banks 11, a plurality of global I/O lines, a serializer/deserializer SERDES 12, and a through silicon via (TSV).

In this case, the memory chip 10 can be called a slice in a stacked structure.

The memory chip 10 is shown as an example in which 256 global I/O lines and 128 data input/output terminals DQs are applied to each channel. In this case, the serializer/deserializer 12 may be a 2:1 SERDES, and 128 TSVs corresponding to the 128 data input/output terminals DQs may be configured.

FIG. 2 is a view showing the structure of a conventional stacked semiconductor memory 20.

As shown in FIG. 2, the conventional stacked semiconductor memory 20 may be manufactured by stacking slices which have a structure as shown in FIG. 1.

FIG. 2 shows an example in which four slices S0-S3 are stacked.

With respect to the four stacked slices S0-S3, an address signal/command/chip selection signal bus ADD/CMD/CS is allocated according to each channel, and a data bus 128DQ is also allocated according to each channel.

The four stacked slices S0-S3 are shown as example in which each slice is configured with only one channel.

The address signal/command/chip selection signal bus ADD/CMD/CS and the data bus 128DQ are electrically coupled to a controller (not shown) through TSVs.

FIG. 3 is a write/read timing diagram according to the structure of FIG. 2.

The conventional stacked semiconductor memory 20 described above operates in a 2-bit prefetch scheme (Prefetch=2).

In this case, Write Latency (WL)=2, CAS Latency (CL)=3, CAS-to-CAS delay (tCCD)=1 tCK; and Burst Length (BL)=2.

Accordingly, the four stacked slices S0-S3 receive or output data through the respective data buses 128DQ according to two write commands WT or two read commands RD which are received sequentially at intervals of 1 tCK.

The conventional technology employs a 2-bit prefetch scheme, and thus tCCD becomes 1 tCK. In addition, the Local I/O to Local I/O timing and the Global I/O to Global I/O timing are also generated in units of 1 tCK, so that mixing in a high-frequency operation is caused.

In order to increase a bandwidth, it is necessary to increase a prefetch value or to increase an I/O width.

However, increasing a prefetch value causes an increase in an input/output-related circuit construction, such as local I/O, global I/O, and the like, thereby increasing current and increasing the area of the circuit. Increasing an I/O width also causes the same problems.

### SUMMARY

A memory system capable of increasing a bandwidth, without increasing the area of an input/output-related circuit is described herein.

In an embodiment of the invention, a memory system, including a plurality of stacked slices and a controller electrically coupled to the plurality of slices, includes: the plurality of slices configured to share a command in a preset number unit, wherein a slice performs a data input/output operation; and the controller configured to generate the command and a control signal for selecting slices in the preset number unit from the plurality of slices.

In an embodiment of the invention, a memory system, including a plurality of stacked slices and a controller electrically coupled to the plurality of slices, includes: the controller configured to generate a command, a first control signal, and a second control signal for selecting the plurality of slices in a preset number unit; and slices of the preset number unit configured to perform a data input/output operation corresponding to the command through even-numbered data input/output terminals or odd-numbered data input/output terminals among a plurality of data input/output terminals.

In an embodiment of the invention, a memory system, including a plurality of stacked slices and a controller electrically coupled to the plurality of slices, includes: the plurality of stacked slices configured to form one channel in units of two different slices; and the controller configured to generate a control signal for selecting the two different slices to perform a data input/output operation.

In an embodiment of the invention, a memory system includes: a plurality of stacked slices configured to share an address signal and command in which each slice is configured with only one channel; and a controller configured to provide the plurality of stacked slices with the address signal, command, and a control signal to perform a data transmission operation.

### BRIEF DESCRIPTION OF THE DRAWINGS

Features, aspects, and embodiments are described in conjunction with the attached drawings, in which:

FIG. 1 is a layout diagram illustrating the configuration of a conventional semiconductor memory chip;

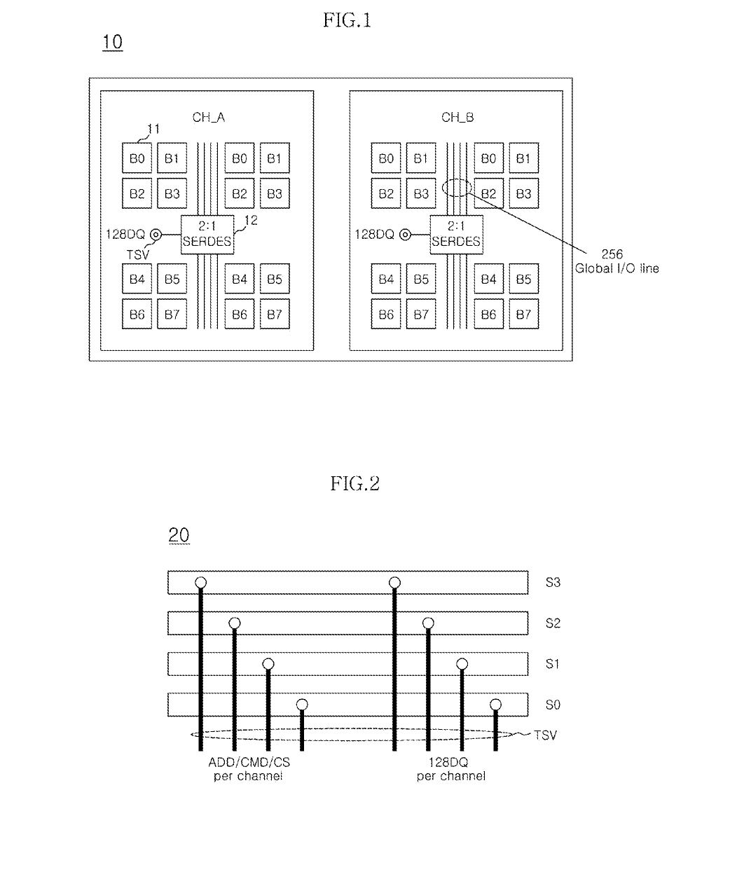

FIG. 2 is a view showing the structure of a conventional stacked semiconductor memory;

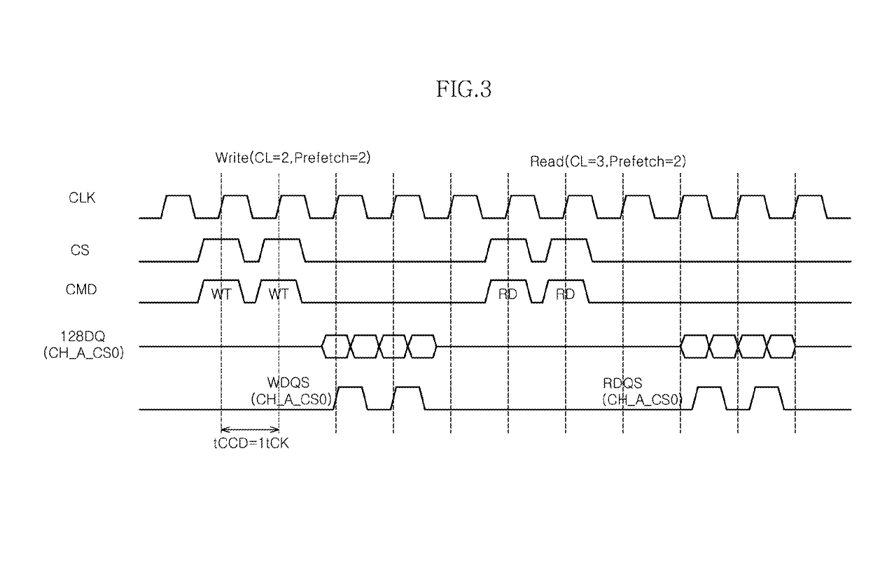

FIG. 3 is a write/read timing diagram according to the structure of FIG. 2;

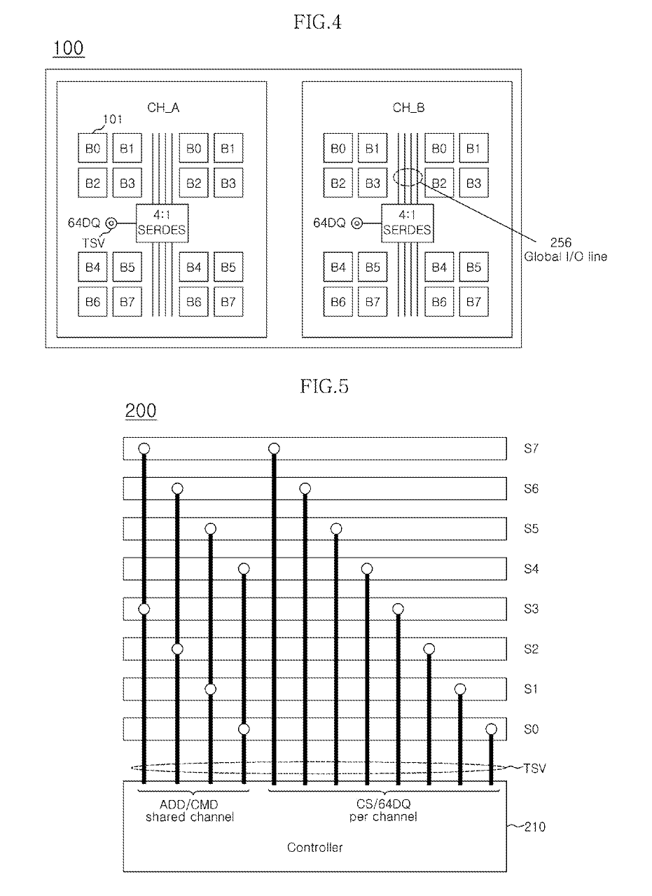

FIG. 4 is a layout diagram illustrating the configuration of a semiconductor memory chip according to an embodiment of the invention;

FIG. 5 is a view illustrating the structure of a memory system according to an embodiment of the invention;

FIG. 6 is a block diagram illustrating an input/output circuit structure of a first slice group capable of being implemented in the structure of FIG. 5;

FIG. 7 is a block diagram illustrating an input/output circuit structure of a second slice group capable of being implemented in the structure of FIG. 5; and

FIGS. 8 to 10 are write/read timing diagrams according to FIG. 5.

### DETAILED DESCRIPTION

Hereinafter, a memory system according to the invention will be described below with reference to the accompanying drawings through various embodiments.

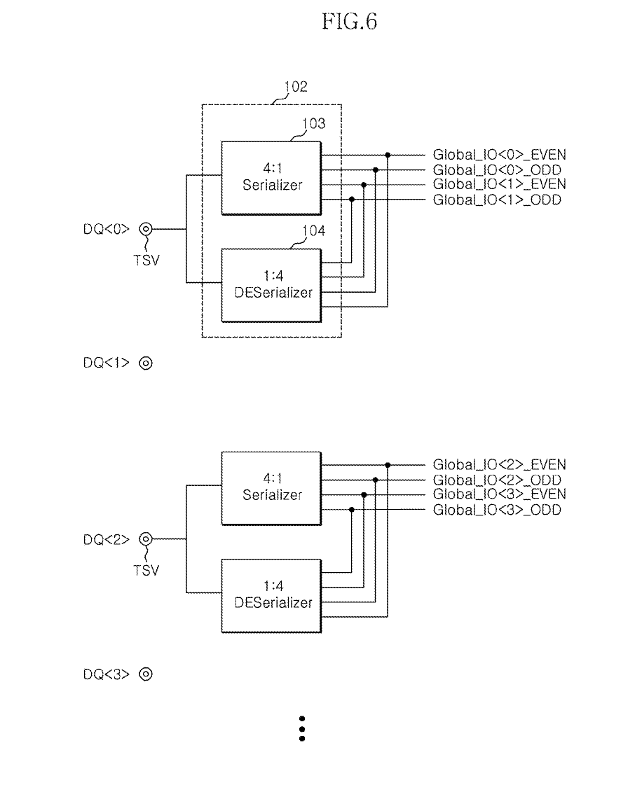

FIG. 4 is a layout diagram illustrating the configuration of a semiconductor memory chip 100 according to an embodiment of the invention.

As illustrated in FIG. 4, a semiconductor memory chip 100 according to an embodiment of the invention may be configured with two channels CH_A and CH_B, wherein each channel may include a plurality of memory banks 101 illustrated by B0-B3, a plurality of global I/O lines electrically coupled to the plurality of memory banks 101, a plurality of serializer/deserializers SERDES electrically coupled the plurality of global I/O lines, and a via (e.g. a through silicon via (TSV)).

In this case, the memory chip 100 may be called a slice in a stacked structure.

Each slice may include global I/O lines (e.g. 256 global I/O lines), data input/output terminals (e.g. 64 DQs), a serializer/deserializer (4:1 SERDES), and 64 TSVs coupled to the 64 DQs, respectively, according to each channel.

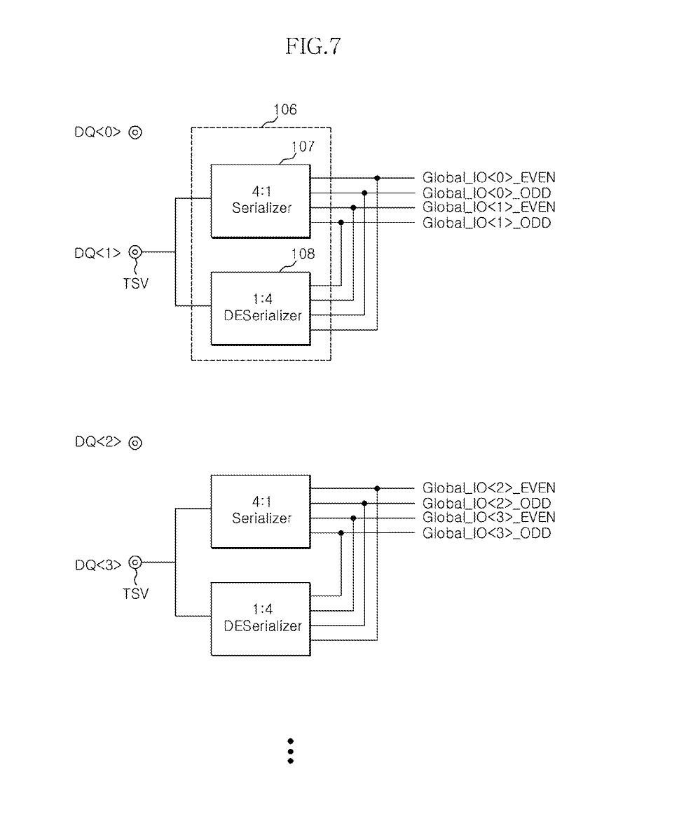

FIG. 5 is a view illustrating the structure of a memory system 200 according to an embodiment of the invention.

As illustrated in FIG. 5, a memory system 200 according to an embodiment of the invention may include a plurality of stacked slices S0-S7 and a controller 210 electrically coupled to the plurality of slices through a via.

In this case, the plurality of slices S0-S7 are shown as an example in which eight slices having a structure as illustrated in FIG. 4 are stacked.

Each of the plurality of stacked slices S0-S7 may be exemplified as being configured with only one channel.

The plurality of stacked slices S0-S7 may be configured in such a manner that two mutually different slices share an address signal/command set ADD/CMD in a preset number unit in units of pairs. A slice may be selected in response to a control signal CS to perform a data input/output operation in response to the address signal/command set ADD/CMD. In this case, when each slice is configured with only one channel, as described above, one independent address signal/command set ADD/CMD may be shared by every two slices.

Two slices, i.e. two channels, sharing an address signal/command set ADD/CMD correspond to substantially one channel. That is to say, one channel may be vertically allocated as two sub-channels.

A control signal/data input/output terminal set CS/64DQ may be allocated according to each channel.

The controller 210 may be configured: to provide the plurality of stacked slices S0-S7 with an address signal ADD, and generate a command CMD, and a control signal CS for selecting slices in the preset number unit from the plurality of slices so that a data input/output operation corresponding to the one channel is performed; to provide the plurality of stacked slices S0-S7 with data by a data input/output operation in response to the command CMD through an even-numbered or odd-numbered data input/output terminal 64DQ; and accordingly, to perform a data transmission/reception operation.

The control signal CS is shown as an example in which a chip select signal CS is used, wherein CS<0:7> can be used to select the plurality of slices S0-S7.

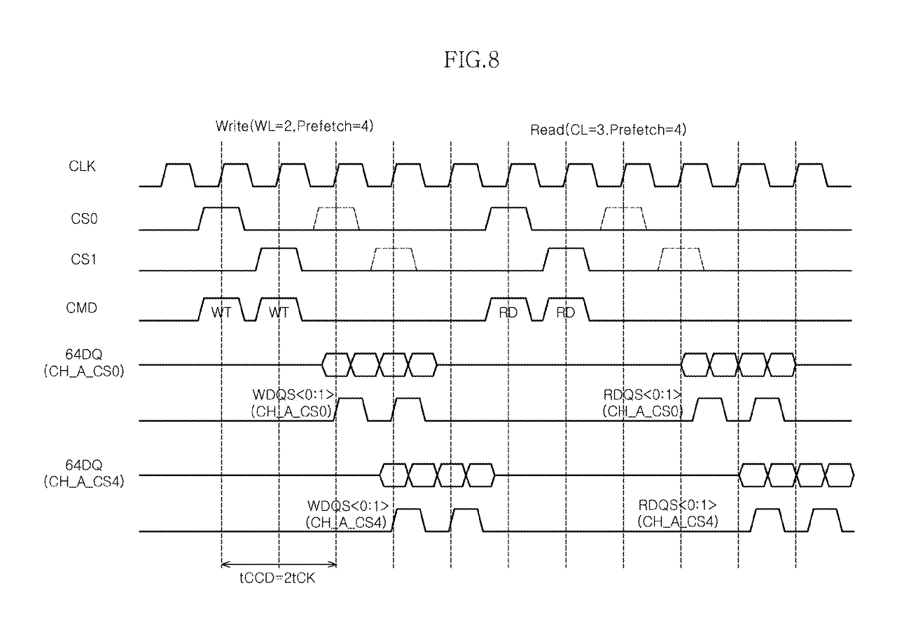

FIG. 6 is a block diagram illustrating the input/output circuit structure of a first slice group S0-S3 capable of being implemented in the structure of FIG. 5.

As illustrated in FIG. 6, each of the first slice group S0-S3 may include a plurality of serializer/deserializers (4:1 SERDESs) 102 which are coupled to TSVs, respectively, corresponding to even-numbered DQs (DQ<0>, DQ<2>, . . . ) of the entire DQs (DQ<0:63>). One of the slices S0-S7 of the preset number unit may be configured to perform the data input/output operation through one of the even-numbered DQs or odd-numbered DQs among the plurality of DQs in response to the command CMD.

For example, a serializer/deserializer 102 coupled to DQ<0> may include a 4:1 serializer 103 and a 1:4 deserializer 104.

The output terminal of the 4:1 serializer 103 and the input terminal of the 1:4 deserializer 104 may be coupled in common to a TSV corresponding to DQ<0>.

The input terminal of the 4:1 serializer 103 and the output terminal of the 1:4 deserializer 104 may be coupled in common to a global I/O “G_IO<0>_EVEN-G_IO<1>_ODD”. Further the output terminal of the 4:1 serializer and the input terminal of the 1:4 deserializer may be coupled in common to a TSV corresponding to DQ<2>, and to a global I/O “G_IO<2>_EVEN-G_IO<3>_ODD”.

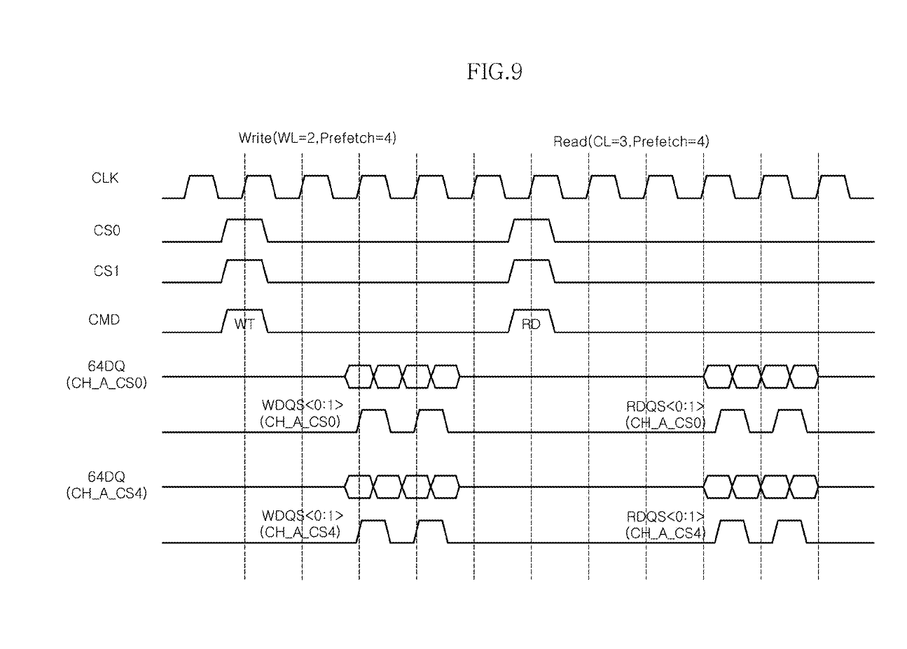

FIG. 7 is a block diagram illustrating the input/output circuit structure of a second slice group S4-S7 may be capable of being implemented in the structure of FIG. 5.

As illustrated in FIG. 7, each of the second slice group S4-S7 may include a plurality of serializer/deserializers 106 which are coupled to TSVs, respectively, corresponding to odd-numbered DQs (DQ<1>, DQ<3>, . . . ) of the entire DQs (DQ<0:63>).

For example, a serializer/deserializer 106 coupled to DQ<1> may include a 4:1 serializer 107 and a 1:4 deserializer 108.

The output terminal of the 4:1 serializer 107 and the input terminal of the 1:4 deserializer 108 may be coupled in common to a TSV corresponding to DQ<1>.

The input terminal of the 4:1 serializer 107 and the output terminal of the 1:4 deserializer 108 may be coupled in common to a global I/O “G_IO<0>_EVEN-G_IO<1>_ODD”. In addition, the input terminal of the 4:1 serializer and the output terminal of the 1:4 deserializer may be coupled in common to a TSV corresponding to DQ<1> and a global I/O “G_IO<2>_EVEN-G_IO<3>_ODD”.

As illustrated in FIGS. 6 and 7, since a 4:1 SERDES structure is used, a CAS-to-CAS delay tCCD may become 2 tCK. In addition, another of the slices of the preset number unit may be configured to perform the data input/output operation through one of the odd-numbered DQs or even-numbered DQs among the plurality of DQs in response to the command CMD.

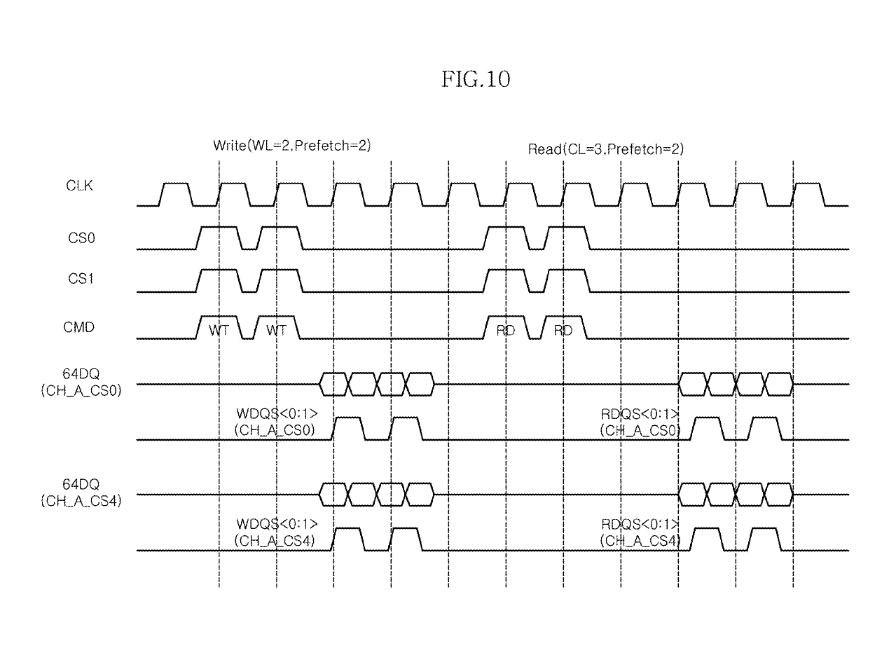

FIGS. 8 to 10 are write/read timing diagrams according to FIG. 5.

A memory system 200 according to an embodiment of the invention may be compatible with not only a channel interleave scheme not also a 4-bit prefetch scheme and a 2-bit prefetch scheme, to which the channel interleave scheme is not applied.

FIG. 8 is a write/read timing diagram according to a channel interleave scheme.

It is assumed that the controller 210 may be configured to generate a command CMD, a first control signal CS0 and a second control signal CS1 for selecting two slices S0 and S4 in a preset number unit, i.e. two sub-channels, sharing an address signal/command set ADD/CMD among the plurality of slices S0-S7.

In this case, according to an embodiment of the invention, the operating condition of the memory system 200 may be as follows: 4-bit Prefetch (Prefetch=4); Write Latency (WL)=2; CAS Latency (CL)=3; and Burst Length (BL)=4, wherein tCCD=2 tCK.

First, a write operation will be described.

The controller 210 may output a write command WT, an address signal ADD, and a first control signal CS0 at a first timing; and output a write command WT, an address signal ADD, and a second control signal CS1 at a second timing which is subsequent to the first timing.

In this case, the first timing may be the rising edge (or falling edge) of a specific clock pulse in a clock signal CLK. Accordingly, the second timing may be the rising edge (or falling edge) of a clock pulse which is subsequent to the first timing.

Then, the controller 210 may output a strobe signal WDQS<0:1> at each of third and fourth timings which are subsequent to the second timing.

The slice S0 corresponding to a first sub-channel selected in response to the first control signal CS0 at the first timing may receive data through a data bus 64DQ according to a strobe signal WDQS<0:1>.

Then, the slice S4 corresponding to a second sub-channel selected in response to the second control signal CS1 at the second timing may receive data through a data bus 64DQ according to a strobe signal WDQS<0:1>.

Consequently, the controller 210 may alternately generate the first control signal CS0 and the second control signal CS1 in response to the respective consecutive write commands so as to input data to each of the slices S0 and S4 corresponding to the first sub-channel and second sub-channel, respectively.

Next, a read operation will be described.

The controller 210 may output a read command RD, an address signal ADD, and a first control signal CS0 at a first timing; and output a read command RD, an address signal ADD, and a second control signal CS1 at a second timing which is subsequent to the first timing.

In this case, the first timing may be the rising edge (or falling edge) of a specific clock pulse in a clock signal CLK. Accordingly, the second timing may be the rising edge (or falling edge) of a clock pulse which is subsequent to the first timing.

Then, the controller 210 may output a strobe signal RDQS<0:1> at each of third and fourth timings which are subsequent to the second timing.

The slice S0 corresponding to a first sub-channel selected in response to the first control signal CS0 at the first timing may output data corresponding to an address signal ADD through a data bus 64DQ according to a strobe signal RDQS<0:1>.

Then, the slice S4 corresponding to a second sub-channel selected in response to the second control signal CS1 at the second timing may output data corresponding to an address signal ADD through a data bus 64DQ according to a strobe signal WDQS<0:1>.

Consequently, the controller 210 may alternately generate the first control signal CS0 and the second control signal CS1 in response to the respective consecutive read commands, thereby allowing each of the slices S0 and S4 corresponding to the first sub-channel and second sub-channel, respectively, to output data.

FIG. 9 is a write/read timing according to a 4-bit prefetch scheme to which a channel interleave scheme is not applied.

The memory system 200 according to an embodiment of the invention may operate compatibly with a 4-bit prefetch scheme to which a channel interleave scheme is not applied.

The controller 210 may provide a first control signal CS0 and a second control signal CS1 which have the same value at the same timing. Such a configuration may be achieved by electrically coupling signal lines for transmission of the first control signal CS0 and second control signal CS1 by means of a metal option and the like.

In this case, according to an embodiment of the invention, the operating condition of the memory system 200 may be as follows: 4-bit Prefetch (Prefetch=4); Write Latency (WL)=2; CAS Latency (CL)=3; and Burst Length (BL)=4.

First, a write operation will be described.

The controller 210 may output a write command WT, an address signal ADD, a first control signal CS0, and a second control signal CS1 at a first timing.

In this case, the first timing may be the rising edge (or falling edge) of a specific clock pulse in a clock signal CLK.

Then, the controller 210 may output a strobe signal WDQS<0:1> at a third timing.

The slice S0 corresponding to a first sub-channel and the slice S4 corresponding to a second sub-channel, which are selected at the same time in response to the first control signal CS0 and second control signal CS1 at the first timing, each receive data through a data bus 64DQ according to the strobe signal WDQS<0:1>.

Next, a read operation will be described.

The controller 210 may output a read command RD, an address signal ADD, a first control signal CS0, and a second control signal CS1 at a first timing.

In this case, the first timing may be the rising edge (or falling edge) of a specific clock pulse in a clock signal CLK. Then, the controller 210 may output a strobe signal RDQS<0:1> at a third timing.

The slice S0 corresponding to a first sub-channel and the slice S4 corresponding to a second sub-channel, which are selected in response to the first control signal CS0 and second control signal CS1 at the first timing, may each output data through a data bus 64DQ according to the strobe signal RDQS<0:1>.

FIG. 10 is a write/read timing according to a 2-bit prefetch scheme to which a channel interleave scheme is not applied.

The memory system 200 according to an embodiment of the invention may operate compatibly with a 2-bit prefetch scheme to which a channel interleave scheme is not applied.

The controller 210 may provide a first control signal CS0 and a second control signal CS1 which have the same value at the same timing. Such a configuration may be achieved by electrically coupling signal lines for transmission of the first control signal CS0 and second control signal CS1 by means of a metal option and the like.

In this case, according to an embodiment of the invention, the operating condition of the memory system 200 may be as follows: 2-bit Prefetch (Prefetch=4); Write Latency (WL)=2; CAS Latency (CL)=3; and Burst Length (BL)=2.

First, a write operation will be described.

A write command WT, an address signal ADD, a first control signal CS0, and a second control signal CS1 may be outputted at a first timing; and a write command WT, an address signal ADD, a first control signal CS0, and a second control signal CS1 may be outputted at a second timing which is subsequent to the first timing.

In this case, the first timing may be the rising edge (or falling edge) of a specific clock pulse in a clock signal CLK. Accordingly, the second timing may be the rising edge (or falling edge) of a clock pulse which is subsequent to the first timing.

Then, the controller 210 may output a strobe signal WDQS<0:1> at a third timing.

The slice S0 corresponding to a first sub-channel and the slice S4 corresponding to a second sub-channel, which are selected in response to the first control signal CS0 and second control signal CS1 at the first timing, may each receive data through a data bus 64DQ according to the strobe signal WDQS<0:1>.

Subsequently, the slice S0 corresponding to a first sub-channel and the slice S4 corresponding to a second sub-channel, which are selected in response to the first control signal CS0 and second control signal CS1 at the second timing, may each receive data of 64*2 bits (BL=2) data through a data bus 64DQ according to the strobe signal WDQS<0:1>.

Next, a read operation will be described.

A read command RD, an address signal ADD, a first control signal CS0, and a second control signal CS1 may be outputted at a first timing; and a read command RD, an address signal ADD, a first control signal CS0, and a second control signal CS1 may be outputted at a second timing which is subsequent to the first timing.

In this case, the first timing may be the rising edge (or falling edge) of a specific clock pulse in a clock signal CLK. Accordingly, the second timing may be the rising edge (or falling edge) of a clock pulse which is subsequent to the first timing.

Then, the controller 210 may output a strobe signal RDQS<0:1> at a third timing.

The slice S0 corresponding to a first sub-channel and the slice S4 corresponding to a second sub-channel, which are selected in response to the first control signal CS0 and second control signal CS1 at the first timing, may each output data corresponding to an address signal ADD through a data bus 64DQ according to the strobe signal RDQS<0:1>.

Subsequently, the slice S0 corresponding to a first sub-channel and the slice S4 corresponding to a second sub-channel, which are selected in response to the first control signal CS0 and second control signal CS1 at the second timing, may each output data corresponding to an address signal ADD through a data bus 64DQ according to the strobe signal RDQS<0:1>.

The invention may increase a bandwidth without increasing the area of an input/output-related circuit, and thus can improve a high-frequency operation capability.

While certain embodiments have been described above, it will be understood to those skilled in the art that the embodiments described are by way of example only. Accordingly, the system described herein should not be limited based on the described embodiments. Rather, the system described herein should only be limited in light of the claims that follow when taken in conjunction with the above description and accompanying drawings.

What is claimed is:

1. A memory system, comprising a plurality of stacked slices and a controller electrically coupled to the plurality of slices, the system comprising:
the plurality of slices configured to share a command in a preset number unit, wherein a slice performs a data input/output operation; and
the controller configured to generate the command and a control signal for selecting slices in the preset number unit from the plurality of slices.

2. The system according to claim 1, wherein the plurality of slices are configured to share the command and an address in the preset number unit.

3. The system according to claim 1, wherein one of the slices of the preset number unit is configured to perform the data input/output operation through one of even-numbered data input/output terminals or odd-numbered data input/output terminals among the plurality of data input/output terminals in response to the command.

4. The system according to claim 3, wherein another of the slices of the preset number unit is configured to perform the data input/output operation through one of odd-numbered data input/output terminals or even-numbered data input/output terminals among the plurality of data input/output terminals in response to the command.

5. The system according to claim 1, wherein the plurality of slices are electrically coupled to the controller through a via.

6. The system according to claim 1, wherein each of the plurality of slices comprises one or more channels, and each channel comprises:
a plurality of memory banks;
a plurality of global I/O lines electrically coupled to the plurality of memory banks; and
a plurality of serializer/deserializers electrically coupled to the plurality of global I/O lines.

7. A memory system, comprising a plurality of stacked slices and a controller electrically coupled to the plurality of slices, the system comprising:
the controller configured to generate a command, a first control signal, and a second control signal for selecting the plurality of slices in a preset number unit; and
slices of the preset number unit configured to perform a data input/output operation corresponding to the command through even-numbered data input/output terminals or odd-numbered data input/output terminals among a plurality of data input/output terminals.

8. The system according to claim 7, wherein the plurality of slices are configured to share, in units of pairs, the command and an address.

9. The system according to claim 7, wherein one of the slices of the preset number unit is configured to perform the data input/output operation through the even-numbered data input/output terminals.

10. The system according to claim 9, wherein another of the slices of the preset number unit is configured to perform the data input/output operation through the odd-numbered data input/output terminals.

11. The system according to claim 7, wherein the plurality of slices are electrically coupled to the controller through a via.

12. The system according to claim 7, wherein each of the plurality of slices comprises one or more channels, and each channel comprises:
a plurality of memory banks;
a plurality of global I/O lines electrically coupled to the plurality of memory banks; and
a plurality of serializer/deserializers electrically coupled to the plurality of global I/O lines.

13. A memory system, comprising a plurality of stacked slices and a controller electrically coupled to the plurality of slices, the system comprising:
the plurality of stacked slices configured to form one channel in units of two different slices; and
the controller configured to generate a control signal for selecting the two different slices to perform a data input/output operation corresponding.

14. The system according to claim 13, wherein two mutually different slices corresponding to the one channel are configured to share a command and an address.

15. The system according to claim 13, wherein the plurality of slices comprise mutually independent data input/output terminals.

16. The system according to claim 13, wherein the controller is configured to select one of the two mutually different slices using a first control signal, and to select the other of the two mutually different slices using a second control signal.

17. The system according to claim 13, wherein the controller is configured to use a command and a first control signal in order for a data input/output operation of one of the two mutually different slices to be performed, and to use the command and a second control signal in order for a data input/output operation of the other of the two mutually different slices to be performed.

18. The system according to claim 13, wherein the plurality of slices are electrically coupled to the controller through a via.

19. The system according to claim 13, wherein the plurality of slices comprise:
a plurality of memory banks;
a plurality of global I/O lines electrically coupled to the plurality of memory banks; and
a plurality of serializer/deserializers electrically coupled to the plurality of global I/O lines.
